(19) United States
(12) Patent Application Publication
(10) Pub. No.: US 2026/0365281 A1
(43) Pub. Date: Nov. 19, 2026

(54) MOORING LINE RETENTION DEVICE

(71) Applicant: Brian Jones, Nashville, TN (US)

(72) Inventor: Brian Jones, Nashville, TN (US)

(21) Appl. No.: 19/645,714

(22) Filed: Apr. 13, 2026

Related U.S. Application Data
(60) Provisional application No. 63/804,752, filed on May 13, 2025.

(51) Int. Cl. B63B 21/08; F16G 11/10; F16G 11/14

(52) U.S. Cl. CPC B63B 21/08; F16G 11/10; F16G 11/14

(57) ABSTRACT

A mooring line retention device is provided. The device is configured to secure a marine vessel to a fixed dock structure without requiring manual tying of a mooring rope around the dock structure. The device comprises a tubular body having a first half and a second half joined by at least one pivot point oriented longitudinally, allowing the halves to open and close in a clamshell-like configuration. The interior of the body defines a generally cylindrical cavity dimensioned to receive mooring ropes of various diameters and compositions. The inner surfaces of the cavity incorporate grip features to provide multidirectional frictional resistance against the rope. A locking mechanism is further configured to secure the body in a closed configuration around the rope, thereby compressing the rope against the grip features.

### CROSS REFERENCE TO RELATED APPLICATION

The present application claims priority to, and the benefit of, U.S. Provisional Application No. 63/804,752, which was filed on May 13, 2025, and is incorporated herein by reference in its entirety.

### FIELD OF THE INVENTION

The present invention relates generally to the field of marine vessel mooring lines. More specifically, the present invention relates to a device configured to secure a marine vessel to a fixed dock structure without requiring manual tying of a mooring rope around the dock structure. Accordingly, the present disclosure makes specific reference thereto. Nonetheless, it is to be appreciated that aspects of the present invention are also equally applicable to other like applications, devices, and methods of manufacture.

### BACKGROUND

Unreliable knots in ropes used to secure boats to dock structures present a significant challenge in marine environments. More specifically, when exposed to storm conditions, strong currents, or oscillatory motion, conventional knots often loosen or fail, resulting in vessel drift or damage. The reliability of these knots is further complicated by variability in rope materials and user expertise. Many traditional methods for securing marine vessels involve manual rope tying, which is inherently time-consuming and requires experience, dexterity, and precision. These requirements pose barriers to effective docking, particularly for individuals with limited training or those operating vessels single-handedly. Moreover, changes in environmental conditions, such as sudden wind shifts or tidal surges, frequently necessitate rapid adjustments in mooring configurations, which are difficult to perform with manually tied knots. The inefficiency and unpredictability of conventional rope securing methods often lead to unsafe docking situations. As a result, there is a critical need for a more standardized, intuitive, and secure approach to vessel mooring that reduces dependence on user skill and increases reliability under dynamic conditions.

Therefore, there exists a long-felt need in the art for a mooring line retention device that enables efficient and rapid boat docking without the use of complex knots. There also exists a long-felt need in the art for a mooring line retention device that provides secure retention of ropes under high-tension and adverse weather conditions. Moreover, there exists a long-felt need in the art for a mooring line retention device that allows for easy and reusable adjustment of mooring lines without specialized tools or expertise.

The subject matter disclosed and claimed herein, in one embodiment thereof, comprises a mooring line retention device. The device is configured to secure a marine vessel to a fixed dock structure without requiring manual tying of a mooring rope around the dock structure. The device comprises a tubular body having a first half and a second half joined by at least one pivot point oriented longitudinally, allowing the halves to open and close in a clamshell-like configuration. The interior of the body defines a generally cylindrical cavity dimensioned to receive mooring ropes of various diameters and compositions. The inner surfaces of the cavity incorporate grip features to provide multidirectional frictional resistance against the rope. A locking mechanism is further configured to secure the body in a closed configuration around the rope, thereby compressing the rope against the grip features. During use, the rope is first looped around a dock structure, then inserted into the opened body of the device, after which the body is closed and locked to secure the rope segments in place.

In this manner, the mooring line retention device of the present invention accomplishes all the foregoing objectives and provides a device that eliminates the need for knot tying while docking a marine vessel, thereby reducing the time and skill requirements for docking procedures. The grip features and locking mechanism further ensure that the rope remains firmly secured within the device under variable tension and environmental stresses, thus addressing safety and reliability concerns associated with traditional methods. The ability to open, adjust, and relock the device also rapidly allows users to respond quickly to changing marine conditions without untying and retying ropes. As a result, the mooring line retention device provides a reusable, efficient, and secure solution to vessel mooring, improving operational performance across both experienced and novice users in diverse docking scenarios.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mooring line retention device. The device is configured to secure a marine vessel to a dock structure, such as a cleat, bollard, piling, or post, without requiring manual tying of a mooring rope. As a result, the device enables rapid and secure mooring, making it suitable for single-handed docking, adverse weather conditions, and high-traffic marina environments.

The device is comprised of a tubular body that includes a first half and a second half joined by at least one pivot point. Each half defines a semicylindrical interior that, when closed, forms a cylindrical interior cavity dimensioned to receive a mooring rope. The cavity accommodates ropes of varying diameters and materials, including braided synthetics, fiber ropes, and marine cables. Interior surfaces of the body halves are comprised of grip features that frictionally engage and retain the mooring rope. The grip features may include molded protrusions, elastomeric pads, serrated channels, ridges, compressible materials, or patterned grooves, and may be arranged in any orientation.

A locking mechanism is mounted to the body halves and maintains the body in a closed configuration during use. As a result, the mechanism may apply axial or radial compression to enhance grip engagement and prevent loosening or opening under load.

During use, a user loops the mooring rope, affixed to the marine vessel, around a fixed dock structure and wraps it to increase friction. The body halves are pivoted open to reveal the internal cavity, and both the lead and trailing rope segments are inserted. When closed, the grip features apply multidirectional friction to retain the segments. Once the rope is seated, the locking mechanism is actuated to secure the rope within the cavity. The mechanism applies a clamping force to ensure consistent contact with the grip features, preventing rope displacement under stress. This design allows fast attachment or detachment without knots and is suitable for temporary mooring, rental fleets, or inexperienced users.

The invention also includes a method of use. First, a device comprising a body with two pivotably connected halves, an interior cavity, grip features, and a locking mechanism is provided. A mooring rope is then wrapped around a dock structure, forming lead and trailing segments. The body halves are then opened, and the rope segments are inserted into the cavity. The halves are then closed, and the locking mechanism is actuated to clamp the rope segments against the grip features, securing the rope around the dock structure without tying knots.

Accordingly, the mooring line retention device of the present invention is particularly advantageous as it provides a device that eliminates the need for knot tying while docking a marine vessel, thereby reducing the time and skill requirements for docking procedures. The grip features and locking mechanism further ensure that the rope remains firmly secured within the device under variable tension and environmental stresses, thus addressing safety and reliability concerns associated with traditional methods. The ability to open, adjust, and relock the device also rapidly allows users to respond quickly to changing marine conditions without untying and retying ropes. As a result, the mooring line retention device provides a reusable, efficient, and secure solution to vessel mooring, improving operational performance across both experienced and novice users in diverse docking scenarios and overcoming the limitations of existing devices and methods of use known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a mooring line retention device of the present invention while closed in accordance with the disclosed architecture;

FIG. 2 illustrates a perspective view of one potential embodiment of a mooring line retention device of the present invention while open in accordance with the disclosed architecture;

FIG. 3 illustrates a top view of one potential embodiment of a mooring line retention device of the present invention while closed around a mooring rope that is attached to a dock structure in accordance with the disclosed architecture; and

FIG. 4 illustrates a flowchart of a method of using one potential embodiment of a mooring line retention device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a mooring line retention device that enables efficient and rapid boat docking without the use of complex knots. There also exists a long-felt need in the art for a mooring line retention device that provides secure retention of ropes under high-tension and adverse weather conditions. Moreover, there exists a long-felt need in the art for a mooring line retention device that allows for easy and reusable adjustment of mooring lines without specialized tools or expertise.

The present invention, in one exemplary embodiment, is comprised of a mooring line retention device. The device enables the secure attachment of a marine vessel to a dock structure such as a cleat, bollard, piling, or post without requiring manual knotting of a mooring rope. This configuration allows for rapid and reliable mooring, making the device well-suited for scenarios involving single-handed docking, adverse weather, or congested marina environments.

The device is comprised of a tubular body featuring a first half and a second half joined by at least one pivot point. Each half includes a semicylindrical interior which, when the body is closed, collectively defines a cylindrical cavity configured to receive a mooring rope. The cavity is capable of accommodating ropes of different diameters and materials, including braided synthetic lines, fiber ropes, and marine cables. The interior surfaces of the body halves incorporate grip features designed to frictionally retain the rope that may include molded protrusions, elastomeric pads, serrated channels, ridges, compressible materials, or patterned grooves, and may be arranged in any orientation. Mounted to the body halves is a locking mechanism designed to maintain the body in a closed configuration during operation. This mechanism may apply axial or radial compression to enhance engagement between the grip features and the mooring rope, thereby preventing unintended loosening or opening under load.

During operation, the user loops the mooring rope around a dock structure and may wrap the rope to increase surface friction. The body halves are then pivoted to an open position to expose the internal cavity, allowing insertion of both the lead and trailing rope segments. Upon closing the body, the grip features exert multidirectional friction to retain the rope segments. The locking mechanism is then actuated to secure the rope within the cavity, applying clamping force that ensures firm contact with the grip features and prevents slippage under mechanical stress. This configuration enables rapid mooring or release without the need for knots, making the device advantageous for temporary docking, rental vessels, or users with limited experience.

The invention further includes a method of use. The method begins with providing a device comprised of a body with two pivotably connected halves, an interior cavity, grip features, and a locking mechanism. A mooring rope is then wrapped around a dock structure to form lead and trailing segments. The body halves are opened, and the rope segments are inserted into the cavity. The body is closed, and the locking mechanism is actuated to clamp the rope segments against the grip features, thereby securing the rope without tying knots.

As a result, the device provides a solution that eliminates the need for knot tying during docking procedures, thereby reducing the time and skill required. The grip features and locking mechanism further work together to maintain rope security under varying tension and environmental stresses, addressing safety and reliability concerns inherent in conventional techniques. The device also allows for quick adjustment and relocking in response to changing marine conditions, without necessitating the untying or retying of ropes. Therefore, the mooring line retention device offers a reusable, efficient, and secure approach to vessel mooring, enhancing performance across a wide range of user skill levels and docking situations, and overcoming limitations present in known devices and methods.

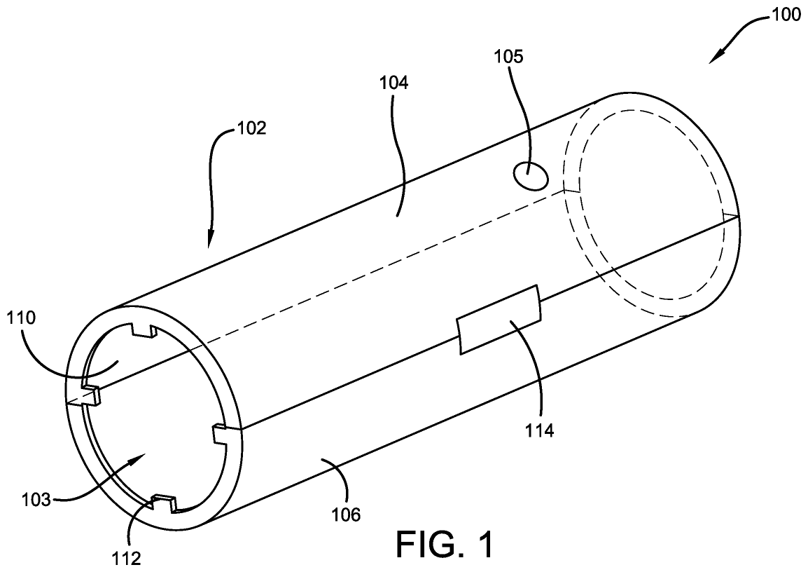

Referring initially to the drawings, FIG. 1 illustrates a perspective view of one potential embodiment of a mooring line retention device 100 of the present invention while closed in accordance with the disclosed architecture. The device 100 is configured to secure a marine vessel to a dock structure 101, such as but not limited to a cleat, bollard, piling, or post, without requiring manual tying of a mooring rope 10 around/to the same. As a result, the device 100 is particularly advantageous for vessel operators who require rapid, efficient, and secure mooring methods, including single-handed docking scenarios, adverse weather mooring, or high-traffic marina environments. The device 100 may further facilitate quick deployment and reliable retention of mooring lines 10 under variable tension, vibration, or oscillatory conditions.

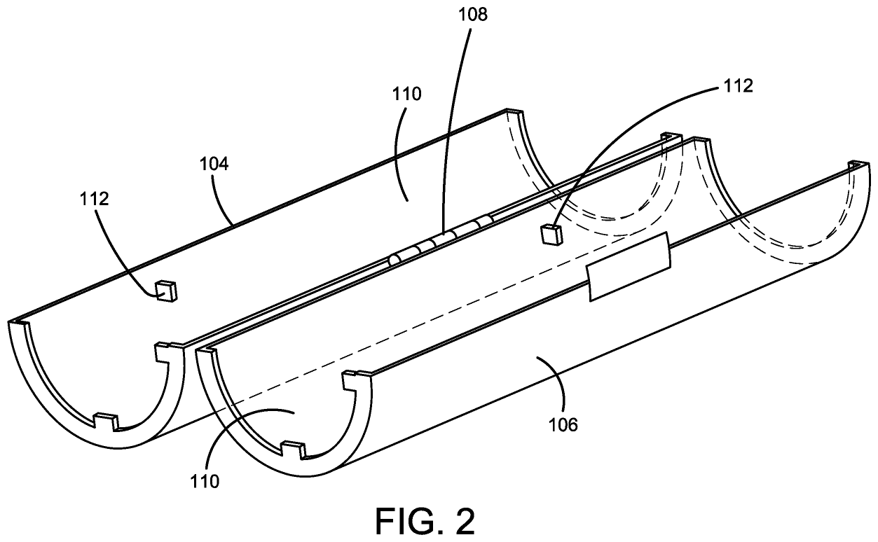

The device 100 is comprised of a body 102. The body 102 is preferably tubular/cylindrical, but may be any size, shape, and diameter. In one embodiment, the tubular body 102 is comprised of a first half 104 and a second half 106, wherein the two halves 104, 106 are connected by at least one pivot point 108, as seen in FIG. 2. The pivot point 108 may be comprised of mechanical hinges, flexible membrane joints, live hinges molded into polymeric materials, rotary couplings, etc. The pivot point 108 may be oriented along a longitudinal axis of the tubular body 102 to enable rotational opening and closing of the halves 104, 106 in a clamshell-like configuration.

Each half 104, 106 may define a semicylindrical interior 110, such that when the tubular body 102 is transitioned to a closed configuration, the combined interiors form a generally cylindrical interior cavity 103 (as seen in FIG. 1) dimensioned to receive a mooring rope 10. The internal cavity 103 may accommodate ropes 10 of variable diameters and materials, including but not limited to braided synthetic lines, twisted fiber ropes, or coated marine cables.

The body 102 may be fabricated from marine-grade materials such as but not limited to high-density polyethylene (HDPE), fiberglass-reinforced nylon, stainless steel (316 grade or higher), anodized aluminum, or thermoplastic elastomers. Additional surface treatments 105 may include but are not limited to UV-resistant coatings, hydrophobic films, grip areas made of anti-slip material (such as but not limited to rubber) and/or anti-slip textures (of any type) to improve handling and environmental durability.

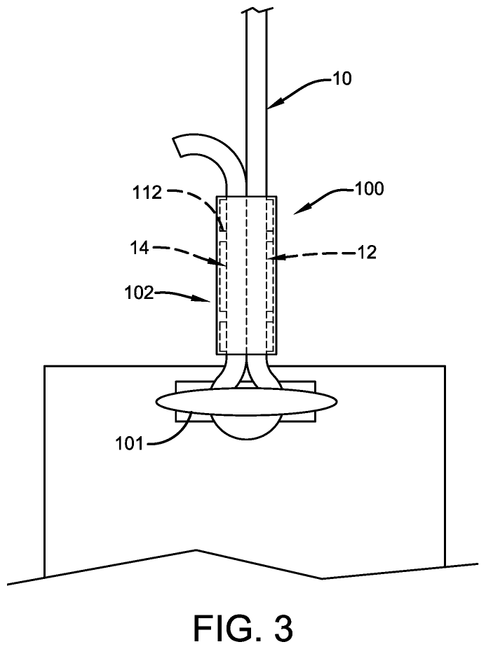

The interior surfaces 105 of the halves 104, 106 may be comprised of grip features 112 configured to frictionally engage and retain the mooring rope 10, as seen in FIG. 3. The grip features 112 may be comprised of but are not limited to molded protrusions, embedded elastomeric pads, detachable inserts, serrated channels, ridges, compressible materials such as silicone or rubber, longitudinal grooves, helical ribs, cross-hatching, checkerboard matrices, concentric rings, texture patterns, etc. The grip features 112 may be arranged in any pattern/orientation across the surfaces 105.

A locking mechanism 114 may be integrated into or mounted onto the halves 104, 106 and may be configured to maintain the body 102 in the closed configuration around a rope 10 during use, as seen in FIG. 3. The locking mechanism 114 may be comprised of mechanical fasteners such as but not limited to over-center cam locks, rotating latch assemblies, spring-loaded clasps, detent-based snap closures, hook-and-loop retention straps, threaded collars, quick-release buckles, etc. The mechanism 114 may apply axial or radial compression, thus enhancing the engagement of the grip features 112 with the mooring rope 10 and preventing unintentional loosening or opening due to tension fluctuations or impact loads.

During operation, a user may loop the mooring rope 10, which is affixed to the marine vessel at one end, around a fixed dock structure 101 such as a cleat or peg (as seen in FIG. 3). The rope 10 may be wrapped at least once to increase surface friction and minimize the risk of slippage. The user may then pivot the halves 104, 106 into the open configuration, revealing the internal cavity 103. The user may insert both the lead segment 12 of the mooring rope 10 (extending toward the vessel) and the trailing segment 14 (returning from the dock structure) into the cavity 103. The internal grip features 112 may be positioned to apply multidirectional frictional resistance against the inserted segments 12, 14 when the halves 104, 106 are returned to the closed position.

Once the mooring rope 10 is fully seated within the cavity 103, the user may actuate the locking mechanism 114, thereby retaining the rope 10 within the tubular body 102. The locking mechanism 114 may apply a mechanical clamping force to maintain consistent contact between the rope 10 and grip features 112. This configuration may prevent rope displacement or unintentional release, even when subjected to torsional movement, wave impact, or lateral loading from the marine vessel. The design may facilitate quick attachment or detachment without the need for knots, making it particularly suitable for temporary mooring, rental fleets, or inexperienced users.

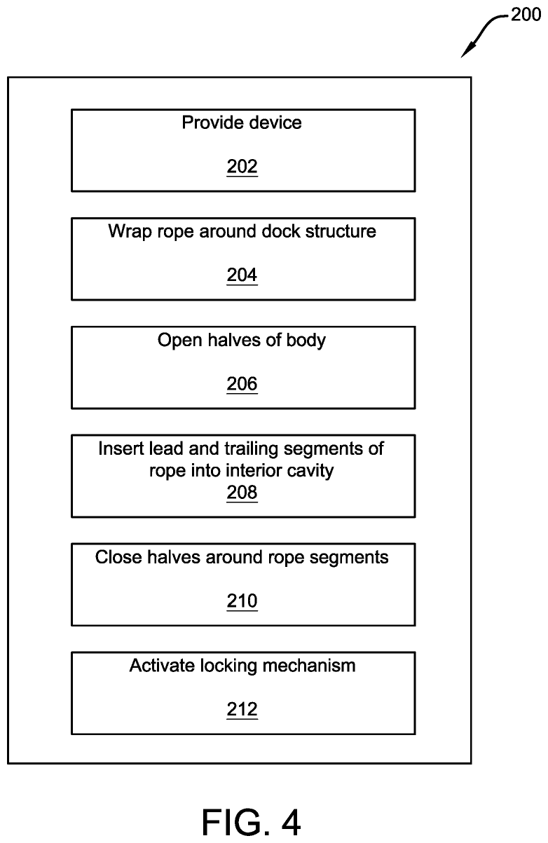

The present invention is also comprised of a method of using 200 the device 100, as seen in FIG. 4. First, a device 100 is provided comprised of a body 102, the body 102 comprised of a first half 104, a second half 106, at least one pivot point 108 connecting the halves 104, 106, a cylindrical interior cavity 103 defined by the halves 104, 106, grip features 112 disposed on interior surfaces 105 of the halves 104, 106, and a locking mechanism 114 [Step 202]. Then, a mooring rope 10 affixed to a marine vessel at one end may be wrapped around a dock structure 101 such as a cleat, bollard, piling, or post, forming a lead segment 12 and a trailing segment 14 [Step 204]. Next, the halves 104, 106 may be pivoted about the pivot point 108 into an open configuration to expose the interior cavity 103 [Step 206]. Then, the lead segment 12 and the trailing segment 14 of the mooring rope 10 may be inserted into the interior cavity 103 such that the rope segments contact the grip features 112 [Step 208]. Next, the halves 104, 106 may be pivoted into the closed configuration to enclose the rope segments 12, 14 within the cavity 103 [Step 210]. Finally, the locking mechanism 114 may be actuated to retain the body 102 in the closed configuration and to apply mechanical clamping force to the rope segments 12, 14 against the grip features 112, thereby securing the mooring rope 10 within the device 100 and around the structure 101 as if it had been knotted around the structure 101 [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “mooring line retention device” and “device” are interchangeable and refer to the mooring line retention device 100 of the present invention.

Notwithstanding the foregoing, the mooring line retention device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the mooring line retention device 100 as shown in the FIGS. are for illustrative purposes only, and that many other sizes and shapes of the mooring line retention device 100 are well within the scope of the present disclosure. Although the dimensions of the mooring line retention device 100 are important design parameters for user convenience, the mooring line retention device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mooring line retention device comprising:
a body comprising a first half and a second half;
a pivot point connecting the first half and the second half and allowing rotational movement of the first half and the second half between an open configuration and a closed configuration;
an interior cavity defined by the first half and the second half in the closed configuration;
a grip feature; and
a locking mechanism configured to maintain the body in the closed configuration.

2. The mooring line retention device of claim 1, wherein the grip feature is comprised of a molded protrusion.

3. The mooring line retention device of claim 1, wherein the grip feature is comprised of an elastomeric pad.

4. The mooring line retention device of claim 1, wherein the grip feature is comprised of a channel or a ridge.

5. The mooring line retention device of claim 1, wherein the grip feature is comprised of a compressible material.

6. The mooring line retention device of claim 1, wherein the grip feature is comprised of a texture pattern.

7. The mooring line retention device of claim 1, wherein the grip feature is comprised of a groove.

8. The mooring line retention device of claim 1, wherein the pivot point is comprised of a hinge.

9. A mooring line retention device comprising:
a body comprising a first half and a second half;
a pivot point connecting the first half and the second half and allowing rotational movement of the first half and the second half between an open configuration and a closed configuration;
an interior cavity defined by the first half and the second half in the closed configuration;
a first grip feature disposed on a first interior surface of the first half and a second grip feature disposed on the second interior surface of the second half; and
a locking mechanism configured to maintain the body in the closed configuration and apply a mechanical clamping force to the first half and the second half.

10. The mooring line retention device of claim 9, wherein the body is comprised of a UV-resistant coating.

11. The mooring line retention device of claim 9, wherein the body is comprised of a hydrophobic film.

12. The mooring line retention device of claim 9, wherein the body is comprised of a grip area.

13. The mooring line retention device of claim 12, wherein the grip area is comprised of an anti-slip material.

14. The mooring line retention device of claim 12, wherein the grip area is comprised of an anti-slip texture.

15. The mooring line retention device of claim 9, wherein the locking mechanism is comprised of a clasp.

16. The mooring line retention device of claim 9, wherein the locking mechanism is comprised of a strap.

17. The mooring line retention device of claim 9, wherein the locking mechanism is comprised of a latch.

18. The mooring line retention device of claim 9, wherein the locking mechanism is comprised of a cam lock.

19. The mooring line retention device of claim 9, wherein the locking mechanism is comprised of a snap closure.

20. A method of using a mooring line retention device, the method comprising the following steps:
providing a mooring line retention device comprised of a body comprising a first half, a second half, a pivot point connecting the first half and the second half, an interior cavity defined by the first half and the second half, a first grip feature disposed on a first interior surface of the first half and a second grip feature disposed on a second interior surface of the second half, and a locking mechanism;
wrapping a mooring rope affixed to a marine vessel around a dock structure to form a lead segment and a trailing segment;
pivoting the first half and the second half into an open configuration to expose the interior cavity;
inserting the lead segment and the trailing segment of the mooring rope into the interior cavity such that the lead segment and the trailing segment contact the first grip feature and the second grip feature;
pivoting the first half and the second half into a closed configuration to enclose the lead segment and the trailing segment within the interior cavity; and
actuating the locking mechanism to retain the body in the closed configuration and apply a mechanical clamping force to the leading segment and the trailing segment against the first grip feature and the second grip feature.
